(19) United States
(12) Patent Application Publication
(10) Pub. No.: US 2023/0363870 A1
(43) Pub. Date: Nov. 16, 2023

(54) PUMP CONFIGURATIONS FOR ORAL IRRIGATORS

(71) Applicant: WATER PIK, INC., Fort Collins, CO (US)

(72) Inventor: Robert D. WAGNER, Fort Collins, CO (US)

(21) Appl. No.: 18/144,416

(22) Filed: May 8, 2023

Related U.S. Application Data
(60) Provisional application No. 63/341,803, filed on May 13, 2022.

(51) Int. Cl. A61C 17/02; A61C 1/00

(52) U.S. Cl. CPC A61C 17/0202; A61C 1/0092

(57) ABSTRACT

Various configurations for a pump for oral irrigators. In one embodiment, a pump is disclosed that includes a connecting rod and a piston. The piston includes a sidewall defining a piston cavity and a rod cutout defined in the sidewall where the rod cutout enables insertions of a portion of the connecting rod into the piston cavity, where after insertion the connecting rod extends from the piston cavity past a bottom edge of the sidewall.

### CROSS REFERENCE TO RELATED APPLICATIONS

The present application claims priority to U.S. Provisional Application No. 63/341,803 titled “Pump Configurations for Oral Irrigators” and filed on May 13, 2022, which is incorporated herein for all purposes.

### TECHNICAL FIELD

The present disclosure relates generally to oral health devices, such as oral irrigators.

### BACKGROUND

Many people use oral irrigators, to maintain and improve oral health. Many oral irrigators include an electrically driven pump that pumps fluid from a reservoir to a handle. The pump assembly and drive assembly for operating the pump typically include a motor, a pump and/or gear housing, and various linkages. The pump assembly components and couplings can be difficult to assemble, require multiple different parts, and/or require separate fittings to connect together. As such, there is a need for improved pump assembles and/or drive assemblies for oral irrigators and other oral health devices.

### SUMMARY

According to one or more embodiments of the present disclosure, an oral irrigator is disclosed. The oral irrigator includes a connecting rod and a piston, where the piston includes a sidewall defining a piston cavity and a rod cutout defined in the sidewall. The rod cutout enables insertion of a portion of the connecting rod into the piston cavity and after insertion, the connecting rod extends from the piston cavity past a bottom edge of the sidewall.

According to one or more embodiments of the present disclosure, an oral irrigator is disclosed that includes a reservoir, a handle fluidly coupled to the reservoir, and a pump configured to pump fluid from the reservoir to the handle. The pump includes a connecting rod and a piston coupled to the connecting rod, where the piston includes a rod cutout defined within a sidewall of the piston.

According to one or more embodiments of the present disclosure, a method of assembling an oral irrigator is disclosed. The method includes inserting a connecting rod into a sidewall cutout of the piston such that a driven end of the connecting rod extends past a bottom end of the piston and a piston end of the connecting rod is at least partially received within the piston, positioning the connecting rod and piston into a pump chamber, and securing the driven end of the connecting rod relative to the pump chamber.

According to one or more embodiments of the present disclosure a pump for an oral irrigator is disclosed. The pump includes a pump housing defining a pump chamber and a pumping assembly comprising a piston and a connecting rod positioned partially within the piston and exposed to an exterior of the piston both at a piston end and a driven end.

According to one or more embodiments of the present disclosure a pump for an oral irrigator disclosed that includes a drive assembly, a pump housing defining a pump chamber, and a gear housing configured to secure a drive element of the drive assembly in a position within the gear housing, where the pump housing and gear housing are integrally formed.

According to one or more embodiments of the present disclosure, an oral irrigator is disclosed that includes a drive assembly including a driven gear and a gear shaft about which the driven gear rotates, and a pump housing including a continuous wall defining in part a pump sleeve and defining in part a gear shaft for securing the driven gear in a location relative to the pump housing.

According to one or more embodiments of the present disclosure, a pump for an oral irrigator is disclosed. The pump includes a piston operably coupled to a drive element, a pump housing defining a pump chamber in fluid communication with a reservoir and a handle, where the piston is received within the pump chamber, and a pump fitting operably coupled to the pump housing and positioned over an open end of the pump chamber. The pump fitting defines a fitting inlet fluidly coupling the reservoir to the pump chamber and a fitting outlet fluidly coupling the pump chamber to the handle, where the fitting inlet and fitting outlet are formed integrally by a continuous wall.

According to one or more embodiments of the present disclosure, a fitting for a pump for an oral irrigator is disclosed. The fitting may include a fitting plate configured to engage with and secure to a pump housing, a hub positioned in a central region of the fitting plate, a fitting inlet including an inlet connector extending outwards from a first location of the hub, and a fitting outlet including an outlet connector extending outwards from a second location of the hub, where the fitting inlet and fitting outlet are formed by a continuous wall.

Additional features are set forth in part in the description that follows and will become apparent to those skilled in the art upon examination of the specification and drawings or may be learned by the practice of the disclosed subject matter. A further understanding of the nature and advantages of the present disclosure may be realized by reference to the remaining portions of the specification and the drawings, which forms a part of this disclosure.

One of skill in the art will understand that each of the various aspects and features of the disclosure may advantageously be used separately in some instances, or in combination with other aspects and features of the disclosure in other instances. Accordingly, individual aspects can be claimed separately or in combination with other aspects and features. Thus, the present disclosure is merely exemplary in nature and is in no way intended to limit the claims or their applications or uses. It is to be understood that structural and/or logical changes may be made without departing from the spirit and scope of the present disclosure.

The present disclosure is set forth in various levels of detail and no limitation as to the scope of the claimed subject matter is intended by either the inclusion or non-inclusion of elements, components, or the like in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. The claimed subject matter is not necessarily limited to the arrangements illustrated herein, with the scope of the present disclosure is defined only by the appended claims.

### BRIEF DESCRIPTION OF THE DRAWINGS

The description will be more fully understood with reference to the following figures in which components may not be drawn to scale, which are presented as various embodiments of the oral irrigator and/or pump configurations described herein and should not be construed as a complete depiction of the scope of the claimed features.

FIG. 1 is a front isometric view of an oral irrigator including a drive assembly and a pump assembly.

FIG. 2A is front isometric view of a drive assembly and pump assembly.

FIG. 2B is a right side elevation view of the drive assembly and pump assembly of FIG. 2A.

FIG. 3 is an exploded view of the drive assembly and pump assembly of FIG. 2A.

FIG. 4 is a cross-sectional view of the drive assembly and pump assembly taken along line 4-4 in FIG. 2A.

FIG. 5A is a top plan view of an integrated gear housing and pump housing.

FIG. 5B is a cross-sectional of the integrated gear housing and pump housing of FIG. 5A.

FIG. 6A is a side isometric view of a piston.

FIG. 6B is a rear isometric view of the piston of FIG. 6A.

FIG. 7A is a side isometric view of a connecting rod.

FIG. 7B is a right side elevation view of the connecting rod coupled to the piston.

FIG. 7C is a top plan view of the connecting rod coupled to the piston.

FIG. 8A is a front isometric view of a pump fitting.

FIG. 8B is a rear elevation view of the pump fitting of FIG. 8A.

FIG. 8C is a cross-sectional view of the pump fitting of FIG. 8A taken along line 8C-8C.

FIG. 9A illustrates an operation in assembly of a piston and connecting rod of a pump assembly.

FIG. 9B illustrates another operation of assembly of the piston and connecting rod.

FIG. 9C illustrates another operation of assembly of the piston and connecting rod.

FIG. 9D illustrates another operation of assembly of the piston and connecting rod.

FIG. 10A illustrates a cross-sectional view along line 10A-10A in FIG. 2A during a vacuum stroke of the pump assembly.

FIG. 10B illustrates a cross-sectional view along line 10B-10B in FIG. 2A during a compression stroke of the pump assembly.

FIG. 11A illustrates a bottom isometric view of a piston.

FIG. 11B illustrates a side elevation view of the piston of FIG. 11A.

FIG. 12A illustrates a top isometric view of the piston of FIG. 11A coupled to a connecting rod.

FIG. 12B illustrates an exploded view of the piston of FIG. 11A and a connecting rod.

FIG. 13 illustrates a side elevation view of a piston.

FIG. 14 illustrates an exploded view of a drive assembly and pump assembly.

FIG. 15 illustrates a rear isometric view of an integrated gear housing and pump housing.

FIG. 16 illustrates an isometric partially transparent view of the drive assembly and pump assembly of FIG. 14.

FIG. 17 illustrates a partial cutaway view of a pump fitting including an aligned pump inlet and pump outlet.

FIG. 18 illustrates an isometric view of a drive assembly and pump assembly.

FIG. 19 illustrates an exploded view of the drive assembly and pump assembly of FIG. 18.

FIG. 20 is a cross-sectional view taken along line 20-20 in FIG. 18.

Embodiments of the invention and their advantages are best understood by referring to the detailed description that follows. It should be appreciated that like reference numerals are used to identify like elements illustrated in one or more of the figures.

### DETAILED DESCRIPTION

Embodiments of the present disclosure relate to an oral irrigator that may include improved configurations for pump assemblies, pump housings, and/or drive assemblies, all of which may be used together (as shown in various figures) or may be used separately from one another depending on the type of oral irrigator (e.g., countertop versus handheld), spacing/sizing, and the like. As such, the discussion of any particular element, feature, component, assembly, or the like, should be understood as being a standalone element, or may be integrated into a system. Relatedly, although the discussion presented herein is related to oral irrigators, the concepts and embodiments may be applicable other types of oral health devices, such as, but not limited to, combination irrigating brushing devices, or other elements that may pump fluid from one location, such as a reservoir, to another.

In some embodiments, a pump including a connecting rod and a piston is disclosed, where the piston is configured to enable ease of insertion of the connecting rod into a piston cavity. For example, the piston may include a rod cutout or other feature that enables a portion of the connecting rod (e.g., piston end of the connecting rod) to be positioned within a piston cavity or otherwise coupled to the piston. The rod cutout or insertion feature, may be configured to prevent inelastic deformation of the piston during insertion, e.g. the piston may at most deflect or bend but may not have permanent damage, such as stress lines, or the like. For example, the rod cutout may be formed as a cutout defined in a sidewall of the piston that receives the connecting rod therethrough, such as through the sidewall of the piston. In another example, the rod cutout may be formed to weaken or otherwise enable flexibility of the piston sidewall, where the connecting rod is inserted through a bottom of the piston, but the sidewall flexes elastically to increase a diameter of the bottom end of the piston, allowing the connecting rod to be positioned therein. Once positioned in the piston cavity, the sidewall may be relaxed and return to the original position, capturing the connecting rod in the piston. Conventional oral irrigator pump configurations typically required inelastic deformation of the piston in order to position the connecting rod therein. For example, some connecting rods may include a ball end that would be press fit into the piston cavity, where during insertion, the force of ball on the piston wall would cause stress lines and damage to the structure of the piston, which impacted the life and operation of the pump, as well as made assembly difficult and often included damage to the piston from assembly.

In some embodiments, the connecting rod may be configured to include an integrally formed piston end that may span a width of the piston to couple or secure the piston to the connecting rod. For example, the piston end of the connecting rod may be formed as an elongated pin or shaft that is seated in one or more coupling apertures within the piston, securing the connecting rod thereto. During use, the coupling apertures may define bearings that engage against an outer bearing surface of the piston end, enabling smooth movement of the piston and connecting rod. The piston end of the connecting rod may be integrally formed with a shaft of the connecting rod, e.g., formed as a continuous wall or single part, eliminating the need for external fasteners, pins, and the like, to be used to secure the connecting rod to the piston. By eliminating external elements and reducing the part count, manufacturing may be easier, cheaper, and installation faster, reducing the overall cost of the oral irrigator. Further, in some instances, conventional piston coupling mechanisms, such as separate pins, may come lose over time, and could travel outside of the piston, dragging on the pump chamber wall, decreasing efficiency and causing leakage and/or damage to the pump.

In some embodiments, the pump may include an integrated housing (e.g., unitarily formed as a single part) that includes at least a portion of a gear shaft support and defines a pump chamber. For example, a continuous wall may define both the portion of the gear shaft support and the pump chamber. In this manner, the pump chamber may be prevented from moving relative to gear shaft support, despite the high forces experienced between the two elements, helping to increase pump performance, reduce wear, and extend the life of the pump.

In some embodiments, the pump may include a pump fitting having a pump inlet and outlet formed together integrally (e.g., as a unitary part). For example, the pump inlet and pump outlet may be formed together by a continuous wall that defines two separate ports and optionally may include integrated fluid connectors, such as hose barbs, to couple to fluid pathways, such as hoses or tubes. In one example, the pump fitting is a separate component attachable to the pump housing. In another example, the pump fitting is formed integrally with the pump housing, formed as an extension of the pump chamber. The integration of the pump inlet and pump outlet helps to reduce the amount of separate connections to the pump chamber, reducing leakage, and enabling easier manufacturing and assembly of the oral irrigator. The pump fitting may be used with one or more valves that may be positioned within the fitting or located at different positions within the fluid pathways between the reservoir and pump chamber and between the pump chamber and handle or other outlet.

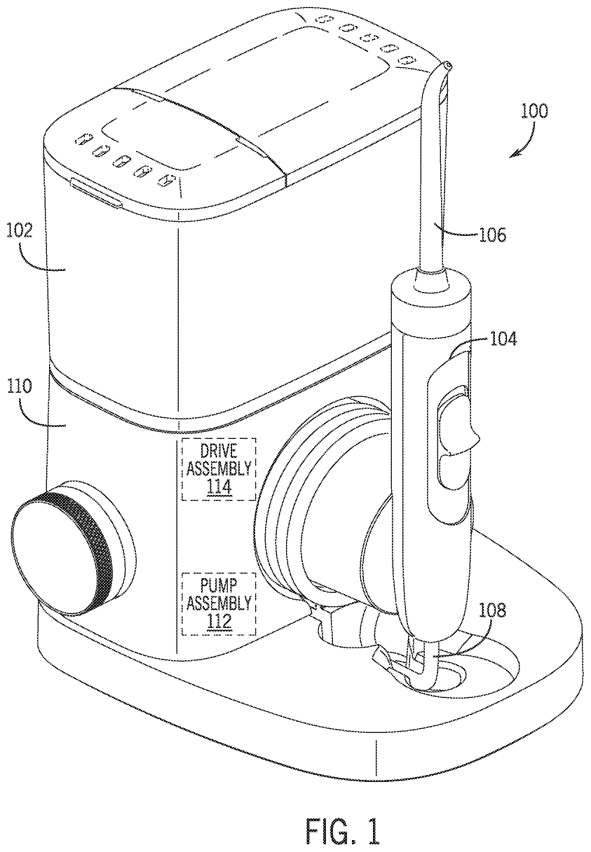

FIG. 1 illustrates an oral irrigator including one or more of the pump configurations described herein. The oral irrigator 100 may include a reservoir 102 that holds a fluid, such as water or mouthwash, to provide the fluid to a pump. In instances where the oral irrigator 100 is a countertop unit, the reservoir 102 may be coupled to a housing 110 or base and where the oral irrigator 100 is a handheld unit the reservoir 102 may be coupled to a handle or hand piece for the oral irrigator 100. Relatedly, the size and volume capacity of the reservoir 102 may be based on the type and configuration of the oral irrigator 100. The reservoir 102 may include a reservoir outlet, such as a port or plug, valve, or the like, that is fluidly coupled to other components of the oral irrigator 100 (e.g., a pump assembly).

With continued reference to FIG. 1, oral irrigator 100 may include a housing 110 or base portion, which in the embodiment illustrated in FIG. 1 acts to support the oral irrigator 100 on a surface (e.g., countertop) and optionally may support the reservoir 102. In some instances, the housing 110 may be configured as a countertop support, but in other iterations may be formed as a handle portion or a portion that is held in the hand of a user during use. The housing 110 supports and/or encloses one or more components of the oral irrigator 100, such as a pump assembly 112 and/or drive assembly 114. Additionally, the housing 110 may include fluid pathways (e.g., tubes, hoses) that direct fluid between different components of the oral irrigator, such as, between the reservoir 102 and the pump assembly 112 and/or the pump assembly 112 and an outlet, such as a handle.

A handle 104 may be fluidly coupled to the reservoir 102, such as via a hose 108 or other fluid connector. The handle 104 may include a tip 106 or other outlet device that can direct fluid from the reservoir 102 into a user's oral cavity. The handle 104 may be configured to be held in a user's hand and in embodiments where the oral irrigator 100 is configured as a handheld device, may include features of the housing 110, e.g., the pump assembly 112 and/or drive assembly 114 may be coupled to or position within the handle 104. The handle 104 may also include features to secure the tip 106 thereto and optionally allow release of the tip 106 therefrom. The tip 106 may be in the form of a jet tip or other tip configuration, e.g., may include bristles (e.g., nozzle integrated with a brush head), tongue scraper, or the like.

The pump assembly 112 may include various pump components that assist in pumping and directing fluid from the reservoir 102 into the handle 104 and tip 106. Configurations and embodiments of the pump assembly 112 will be discussed in more detail below. Similarly, the drive assembly 114 may be operably coupled to the pump assembly 112 and may be configured to include one or more drive elements (e.g., motor, linkages, gears, gear supports, etc.). The drive assembly 114 assists in driving or actuating the pump assembly 112 or components thereof and will be discussed in detail below.

### Drive Assembly

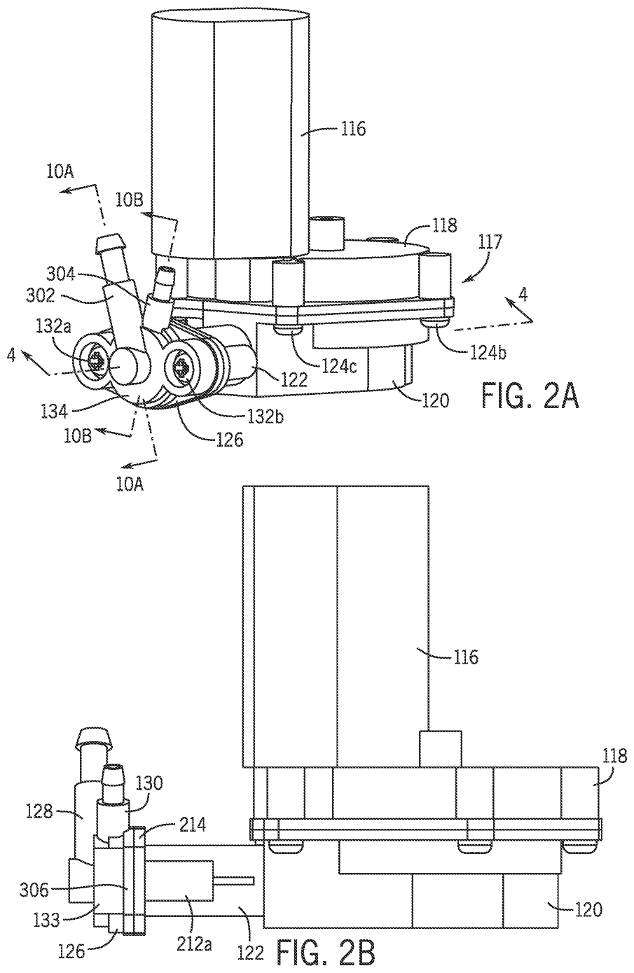

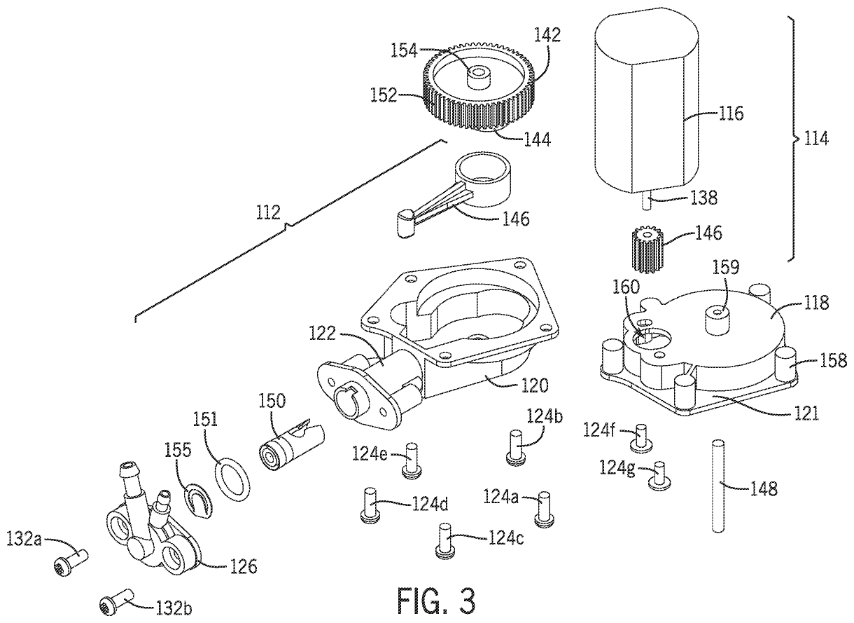

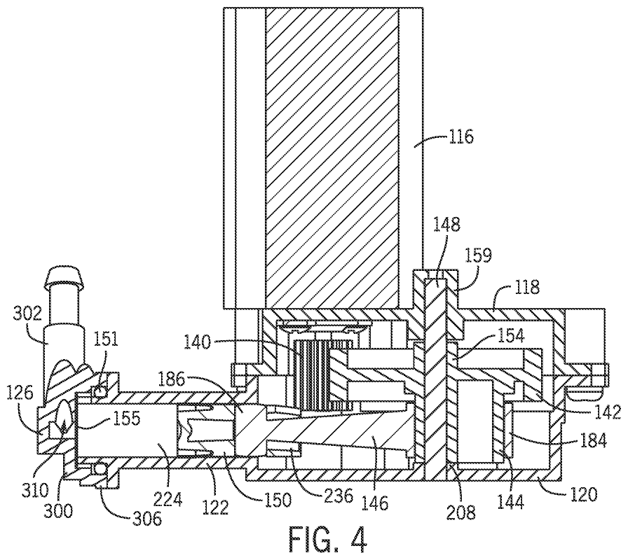

As mentioned above, a drive assembly is disclosed that can be used to drive or actuate the pump assembly. FIGS. 2A and 2B illustrate various views of the pump assembly 112 and drive assembly 114 of the oral irrigator 100. FIG. 3 is an exploded views of the assemblies of FIGS. 2A and 2B. FIG. 4 is a cross-sectional view of the assemblies taken along line 4-4 in FIG. 2A. With reference to FIGS. 2A-4, as mentioned, the drive assembly 114 may include one or more drive elements, including, for example a motor 116. The motor 116 may include a drive shaft 138 and be configured to translate electrical energy into rotational movement or another mechanical movement, e.g., rotate the drive shaft 138 about an axis. The motor 116 is typically connected to a power supply (not shown), such as a battery or power cord.

With reference to FIG. 3, a drive gear 140, which may also form a drive element for the drive assembly 114, may be configured to be coupled to the drive shaft 138. The drive gear 140 may be formed as a pinion or other gear that correspondingly moves another drive element, such as a linkage or additional gear. To that end, the drive gear 140 may include one or more teeth that may mesh with a corresponding drive element (e.g., another gear). In some embodiments, the drive gear 140 is configured to be directly received on the drive shaft 138, but in other embodiments the drive gear 140 may be coupled to the drive shaft 138 in other manners.

With continued reference to FIG. 3, a driven gear 142 may be configured as a drive element for the drive assembly 114 and may be configured to engage with the drive gear 140 or another drive element to be rotated by the motor 116. The driven gear 142 may include an engagement portion 152, which may include one or more teeth that interface with and engage corresponding teeth on another drive element, e.g., drive gear 140. The driven gear 142 may also include a cam 144 that may be coupled to the engagement portion 152, e.g., they may be formed as a single part or may be a separate cam coupled to the engagement portion 152. In various embodiments, the driven gear 142 may include a shaft aperture 154, which may be defined along a center axis or other axis of the driven gear 142 and configured to couple the driven gear 142 to another drive element, e.g., a gear shaft, to support the driven gear 142 and optionally define a rotational axis for the driven gear 142 (e.g., driven gear 142 is rotationally coupled to the gear shaft 138).

A gear shaft 148 may define a drive element for the drive assembly 114 and be configured to connect with one or more components of the drive assembly 114. In one embodiment, the gear shaft 148 or gear support may define a pin or shaft that supports the driven gear 142, e.g., is received within the shaft aperture 154 and secures the driven gear 142 in a position, such as within a housing, while allowing the drive gear 142 to rotate thereabout.

### Pump and Gear Housing

A pump and/or gear housing that may be used with the oral irrigator 100 is disclosed. With reference to FIGS. 2A and 3, a gear housing 117 may be included that may act to support and/or enclose various portions of the drive assembly 114 and/or pump assembly 112. The gear housing 117 may optionally include one or more portions, e.g., a first gear housing 118 and a second gear housing 120, an upper and lower housing, and/or a left and right housing, depending on the configuration. The gear housing 117 may be configured to support the motor 116 and so in some instances may include a motor mount having a shaft aperture 160 that may receive the drive shaft 138 therethrough. Additionally, the gear housing 117 may include a portion of or fully define a shaft support 159. For example, the shaft support 159 may be defined as a nub, protrusion, curb, or the like that may define a shaft aperture, shaft recess, or a portion of the same, therein. In the example shown in FIG. 3, the shaft support 159 may be defined as a protrusion extending from a top surface of the first gear housing 118, but as shown in other figures, the location and configuration of the shaft support 159 may be varied.

The gear housing 117 may include one or more fastening supports 158, such as protrusions or brackets that may receive one or more fasteners 124a, 124b, 124c, 124d, 124e, 124f, 124g, to secure the gear housing 117 together, e.g., secure a first gear housing 118 to a second gear housing 120.

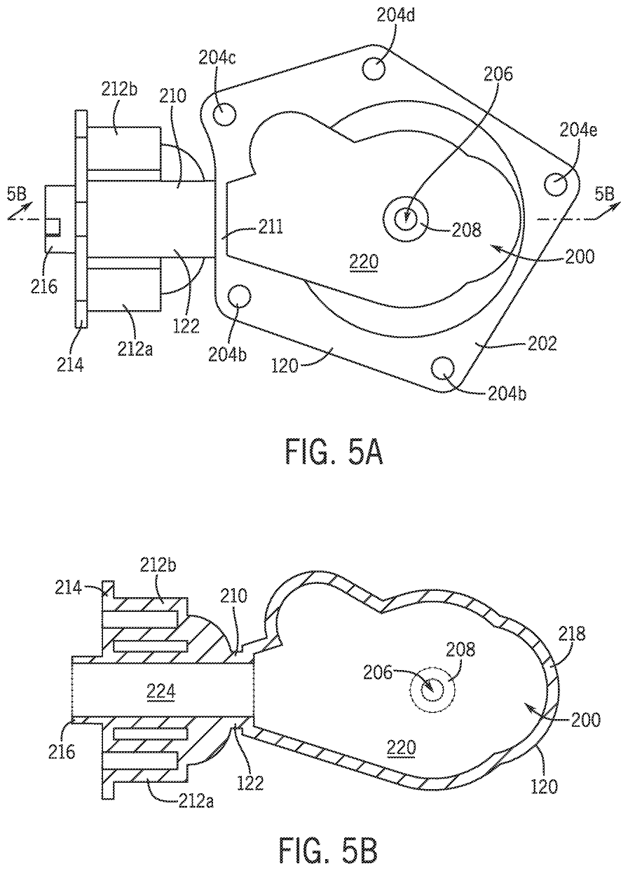

FIGS. 5A and 5B illustrate various views of an embodiment of the gear housing 117 and specifically the second gear housing 120 and a pump housing 122. In this embodiment, the pump housing 122 is integrally formed with a portion of the gear housing 117 that supports a drive element of the drive assembly 114, such as one or more gears, a motor, a linkage, and/or gear shaft. More specifically, the second gear housing 120 may include an outer wall 218 that may be defined as a continuous wall and extend around the perimeter to define both a drive element or gear element compartment 200 and a pump chamber 224. The gear compartment 200 may be shaped and sized to receive various elements of the drive assembly 114 and/or the pump assembly 112. The gear compartment 200 may be connected to the pump chamber 224, such that without a sealing element, such as a component of the pump assembly 112, fluid could flow between the gear compartment 200 and the pump chamber 224.

The outer wall 218 may transition to at a top end to define a top edge 202, which may be configured to interface with another gear housing 117 element, such as the first gear housing 118, and as such may include a lip or outer extension that extends outwardly from the top end of the outer wall 218. The top edge 202 may include one or more fastening apertures 204a, 204b, 204c, 204d, 204e that may be spaced around the outer edge of drive compartment 200. A bottom wall 220 or surface may form a bottom of the gear compartment 200 and may include a drive element support 208 formed therein, either in part or as shown in FIG. 5B, in entirety. In one example, the drive element support 208 is configured to support a drive element of the drive assembly 114 and may include a support structure, e.g., flange or nub, and a recess or aperture 206 defined therein.

With continued reference to FIGS. 5A and 5B, the pump housing 122 may be coupled to and formed with the second gear housing 120. For example, as the outer wall 218 transitions to define the outer perimeter of the second gear housing 120, the outer wall 218 may form a pump extension 210, which may extend from a portion of the outer wall 218. The pump extension 210 includes an outer wall and defines a pump chamber 224 therein and a back wall 211 formed on the interior wall of the gear compartment 200. The pump chamber 224 may be open on either end, with one end open to the gear compartment 200 and the other end, a piston end 216, may form a terminal end of the pump chamber 224 that extends away from the outer wall 218.

Optionally, the pump housing 122 may include one or more coupling features, such as, a pump plate 214 and/or one or more fastening sleeves 212a, 212b. The pump plate 214 may be formed at the piston end 216 of the pump chamber 224 or as shown in FIGS. 5A and 5B, may be slightly set back form the piston end 216, such a portion of the pump extension 210 extends past the pump plate 214. However, in different embodiments, the configuration and orientation of the pump plate 214 may be different.

The fastening sleeves 212a, 212b may be configured to extend parallel to the pump chamber 224 and pump extension 210, such that fasteners that may be used to secure a fitting to the pump extension 210 may be configured to extend in the same direction of the force generated by the pump assembly 112 during operation. In one embodiment, the fastening sleeves 212a, 212b may define cavities or recesses configured to receive a fastener, but in other configurations may be differently configured.

### Piston and Connecting Rod

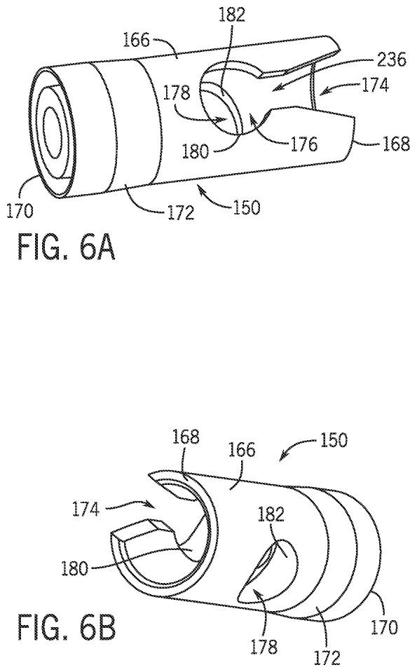

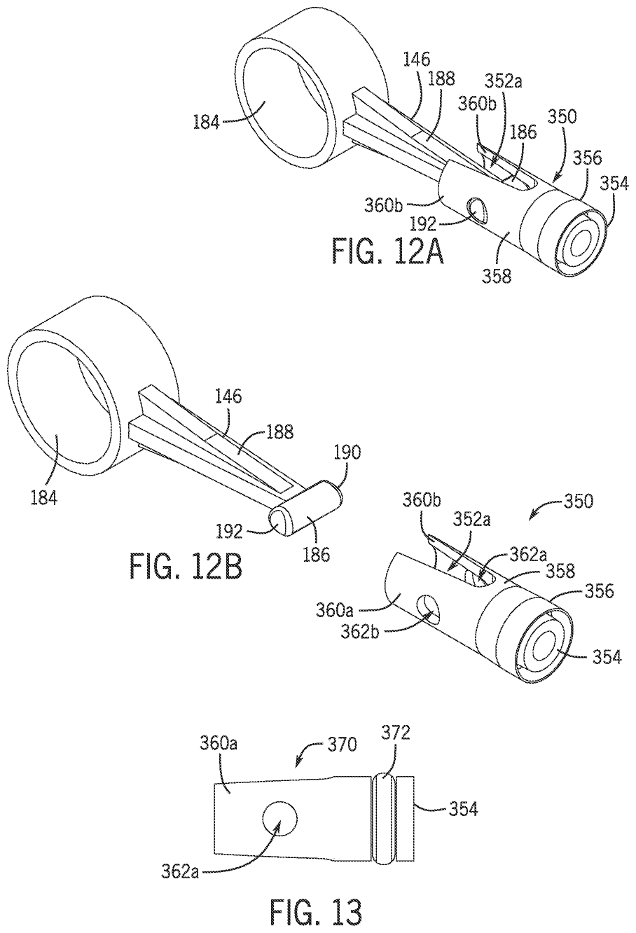

A piston and connecting rod are disclosed that may be used as a portion of pump for the oral irrigator 100. FIGS. 6A and 6B illustrate isometric view of a piston 150. The piston 150 may be included in the pump assembly 112 and configured to be positioned within the pump housing 122 and specifically within the pump chamber 224. The piston 150 may include a rod cutout 174, which may be defined in the piston sidewall 166. In one example, the rod cutout 174 extends from the bottom edge 168 of the piston upwards towards a sealing end 170 and may terminate before a sealing feature 172. The rod cutout 174 is configured to enable insertion of a connecting rod into the piston cavity 236 without causing permanent damage to the piston 150, e.g., without inelastically deforming the piston 150. In one example, the rod cutout 174 may be defined to actually receive a portion of a connecting rod therein and so may have a shape corresponding to a portion of a connecting rod. However, in other embodiments (see, e.g., FIG. 12B), the rod cutout 174 is configured to enable flexibility of the piston sidewall 166 and may be differently configured. Further, there may be a single rod cutout 174, such as shown in FIGS. 6A and 6B or there may be multiple rod cutouts 174. However, in embodiments including a single rod cutout, such as shown in FIGS. 6A and 6B, the piston 150 may have increased strength.

In one example, the rod cutout 174 may have a keyhole or Y shape, that includes a broader base portion, which may define a frustum shape, that extends into a rectangular shaped portion. The rod cutout 174 may also be defined in part by other features in the piston sidewall 166, such as one or more coupling apertures and/or bearings.

In one embodiment, the piston 150 may include at least one coupling aperture, such as a first coupling aperture 176 and a second coupling apertures 178, where the coupling apertures 176, 178 may be defined on opposite sides of the piston sidewall 166. In one embodiment, one or both of the coupling apertures 176, 178 may extend into the rod cutout 174, however, in other iterations the coupling apertures 176, 178 may be differently configured, e.g., positioned on different sides from the rod cutout 174 or positioned above and do not intersect with the rod cutout 174. The coupling apertures 176, 178 may be defined by one or more bearing surfaces to define a bearing 180, 182. In this manner, the piston 150 may include one or more bearings 180, 182 which may be defined on opposite sides of the piston 150 but at a same location on a length of the piston 150. In some embodiments, two bearings may be desired, to ensure a balanced load and preventing formation of a moment. However, depending on the configuration of the connecting rod 146, other types of configurations, such as a piston 150 with a single bearing.

The seal end 170 of the piston 150 along with the sealing feature 172 (e.g., a skirt and/or sealing elements such as O-rings, U-cups, X-rings) seals a portion of the pump chamber 224. The sealing feature 172 is configured to seal against the interior wall of the pump chamber 224 in order to create a vacuum force and fully expel fluid within the pump chamber 224, as discussed in more detail below. The sealing feature 172 may be defined as a flared and flexible skirt that may have a diameter in an undeformed configuration that may be the same as or slightly larger than a diameter of the pump chamber 224, such that when positioned in the pump chamber 224, the skirt may flex to allow insertion into the pump chamber 224 and then expand back out to seal against the walls. A piston sidewall 166 or body extends from and may define in part the sealing feature 172. The piston sidewall 166 may be curved to define an interior piston cavity 236 that may be an interior compartment or area of the piston 150. The piston sidewall 166 may terminate at a bottom edge 168 that forms a terminal end of the piston 150 opposite of the sealing end 170.

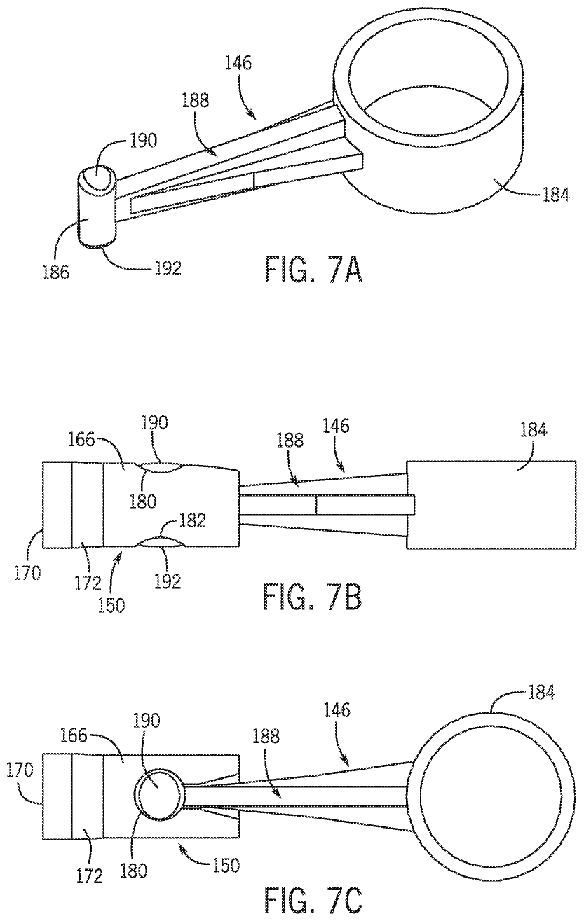

FIG. 7A illustrates an isometric view of a connecting rod 146, which may form a component of the pump assembly 112. A shaft 188 extends from a driven end 184 or first end of the connecting rod 146 and terminates in a piston end 186 or second end. The shaft 188 may optionally have a tapered shape that tapers from a base at the driven end 184 as it extends outwards and then expands again to define the piston end 186, but other configurations are envisioned as well. The piston end 186 defines an integrated pin or rod for the connecting rod 146 to couple to a piston. The piston end 186 may have a width configured to span a width of the piston 150, e.g., the width may be equal to a width of the piston 150 between the two bearings 180, 182. In some embodiments, the piston end 186 may include one or more bearing surfaces 190, 192 that may be configured to engage and enable smooth motion between the connecting rod 146 and the piston 150. For example, the bearing surfaces 190, 192 may include transitional edges that may be beveled and an outer surface that may be curved in one or more directions. The beveled or filet edge of the bearing surfaces 190, 192 may assist in insertion of the piston end 186 into the piston 150, e.g., by leading the piston end 186 into the respective bearing 180, 182 as discussed below.

In one example the bearing surfaces 190, 192 may be curved in two directions, such as being curved in a first direction parallel to a longitudinal axis of the connecting rod 146 and being curved in a second direction perpendicular to the longitudinal axis of the connecting rod 146. As will be discussed in more detail below, a first direction of curvature may enable smooth travel as the piston 150 moves within the pump chamber 224 as the curvature may help to reduce drag as the bearing surfaces 190, 192 may be exposed and may engage the walls of the pump chamber 224. Additionally, a second direction of curvature may be configured to enable the bearing surfaces 190, 192 to match the curvature of the piston sidewall 166.

While the connecting rod 146 is shown as including a piston end 186 extending outwards from the shaft 188 in two directions, e.g., forming a T shape at the end of the shaft 188, in other embodiments the piston end 186 may be differently configured. For example, in one embodiment, the piston end 186 may include a single branch or protrusion that extends from one side of the shaft 188 to define an inverted L or similar structure at the terminal end of the shaft 188. However, in embodiments with a balanced piston end 186, the shaft 188 may be better protected from bending during use and so at select operating forces a “T” shaped piston end 186 may be preferred.

The driven end 184 forms a first end of the connecting rod 146 and is configured to mechanically couple the connecting rod 146 to a drive element of the drive assembly 114. For example, in one embodiment, the driven end 184 may be defined as a cam follower and configured to be positioned around and receive a cam. In these embodiments the driven end 184 may be defined as a circular ring. However, in other embodiments, the connecting rod 146 may include other coupling features that engage with and translate motion from a drive element.

FIGS. 7B and 7C illustrate side and plan views of the piston 150 coupled to the connecting rod 146. As shown in FIGS. 7B and 7C, when coupled together, the bearing surfaces 190, 192 may have a curvature that matches the curvature of the piston 150 at the coupling apertures 176, 178, allowing a substantially continuous outer surface for the connected components. Further, as shown in FIG. 7C, the rod cutout 174 allows the connecting rod 146 to be positioned within the piston 150, without requiring the piston 150 to deform. To insert the connecting rod 146 into the piston 150 the piston end 186 is aligned with the rod cutout 174 and moved into the rod cutout 174 until the piston end 186 seats within the opposite side bearing 182. In this manner, the piston end 186 may extend across a width of the piston 150, e.g., extend between the two bearings 180, 182. The piston end 186 may be coupled to the piston 150 without a separate element, such as a pin or other fastener, being inserted into the connecting rod 146 and/or piston 150.

### Pump Fitting

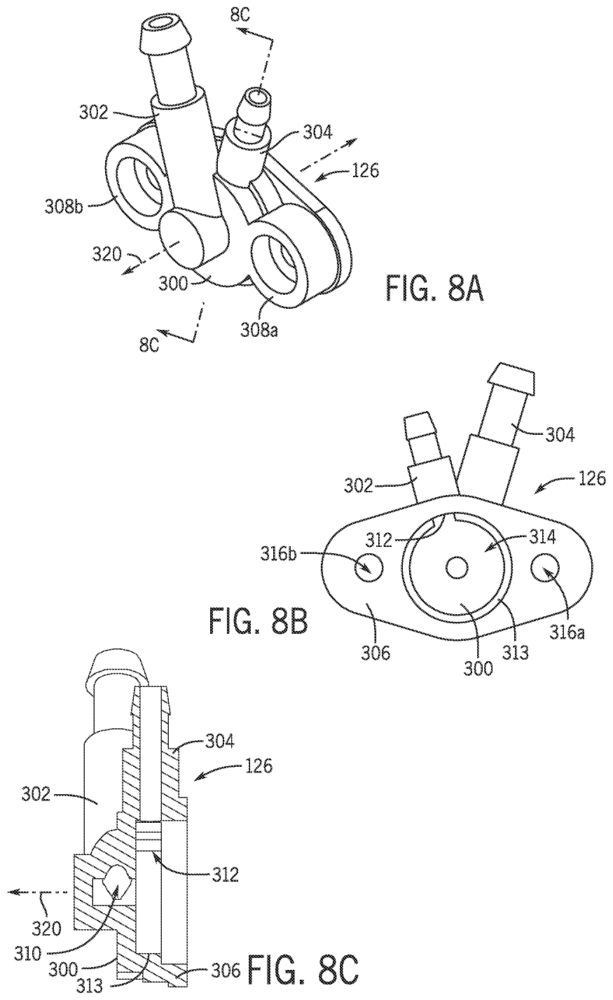

The pump assembly 114 may include a pump fitting 126 that may define a pump inlet and pump outlet (or fitting inlet and fitting outlet) and is configured to both deliver and receive fluid from the pump chamber 224. FIGS. 8A-8C illustrate various views of a pump fitting 126. The fitting 126 may be configured as a unitary or integrally formed part, such that both a pump inlet 310 and a pump outlet 312 are coupled together integrally, such as defined by an unbroken wall or continuous wall. For example, the fitting 126 may be formed as an injection molded component (e.g., plastic injection molded), defining both the pump inlet 310 and the pump outlet 312 in a single piece. Conventionally, pump fittings for oral irrigators defined two separate components for a pump inlet and pump outlet, requiring multiple separate parts, increasing the difficulty of assembly, and requiring more space within the housing of the oral irrigator 100.

With reference to FIGS. 8A-8C, the pump fitting 126 may include a hub 300 that defines a fluid passageway 314 that may be in communication with the pump inlet 310 and the pump outlet 312. With reference to FIGS. 8A and 8C, in some configurations, the pump inlet 310 and the pump outlet 312 may be positioned at different locations along a length of the longitudinal axis 320 of the hub 330. For example, the pump outlet 312 may be positioned closer to the back wall 211 of the pump housing 122 than the pump inlet 310 and both may be along the longitudinal axis 320 of the hub 300. In this configuration, the pump inlet 310 and the pump outlet 312 may be configured in a laterally stacked orientation, such that they are aligned on the axis 320, but at different horizontal locations relative thereto. Optionally, the hub 300 may include a valve retainer 313, which may be defined as a separate element received within hub 300 or as shown in FIG. 8B is formed as a sidewall or protrusion that extends from an interior wall of the hub 300 and may be arranged in a central region of the fitting 126. The valve retainer 313 may be configured to ensure a position and orientation of the valve 155 once positioned within the fitting 126.

Extending from the hub 300 and fluidly connected to the fluid inlet 310 is an inlet connector 302 which may be configured to couple to a fluid passage, such as a tube or hose, that is fluidly connected to a fluid supply, such as the reservoir 102. The inlet connector 302 may be oriented at an angle relative to a center longitudinal axis 320 of the hub 300. Similarly, an outlet connector 304 may extend from the hub 300 and be fluidly connected to the pump outlet 312 and may extend an angle relative to the center longitudinal axis 320 of the hub 300. The angular orientation of the inlet connector 302 and outlet connector 304 may be varied and the two may be oriented in the same direction and angular orientation (see FIG. 17) or different angles (as shown in FIG. 8A). The inlet connector 302 and outlet connector 304 may be configured to couple to a corresponding fluid passage, such as a hose or tube, and include a connector, such as a hose barb, or other coupling element.

With continued reference to FIGS. 8A-8C, the fitting 126 may also include a fitting plate 306 that acts to engage with and couple to the pump housing 122. The fitting plate 306 may be in the form of a relatively planar extension that defines a coupling surface to engage the pump housing 122. The fitting plate 306 may include one or more fastening apertures 316a, 316b defined therethrough to receive one or more fasteners and optionally strengthening collars 308a, 308b may be positioned around the fastening apertures 316a, 316b, such as extending from an outer surface of the fitting plate 306 (facing away from the pump housing 122), in order to protect the fasteners from disengagement and strengthening the connection area on the fitting plate 306.

### Assembly of the Oral Irrigator

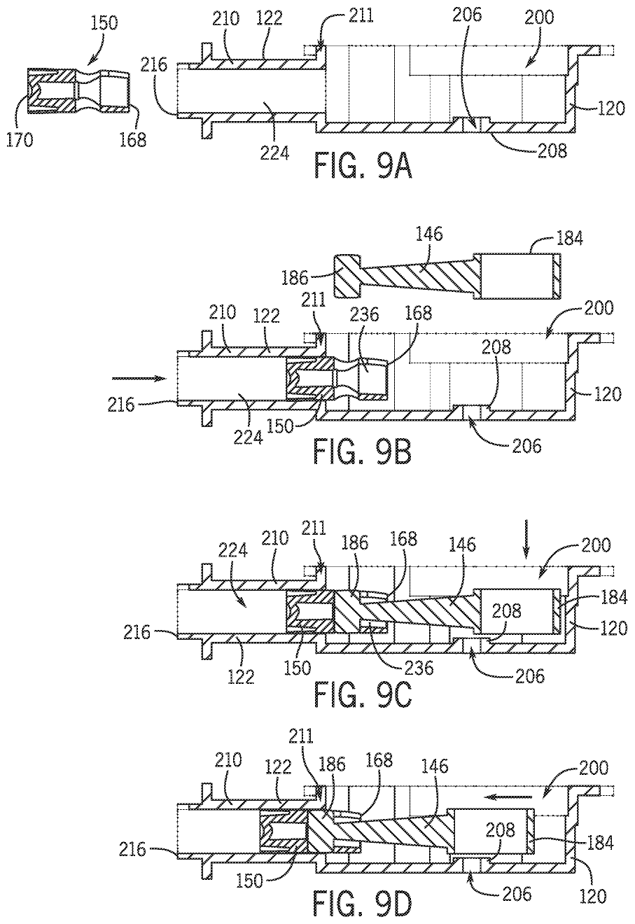

Various components of the pump assembly 112 and drive assembly 114 allow an easier assembly as compared to conventional oral irrigators, as well as space savings to enable smaller and more compact oral irrigators. FIGS. 9A-9D illustrate an example of an assembly process for the pump housing 122, piston 150, and connecting rod 146. With reference to FIG. 9A, the piston 150 may be aligned with the piston end 216 of the pump housing 122 such that the bottom edge 168 faces towards the piston end 216.

With reference to FIG. 9B, the piston 150 is inserted through the piston end 216 of the pump chamber 224 and pushed through the pump chamber 224 until the bottom edge 168 extends past the back wall 211. Specifically the piston 150 is configured such that the bearings 180, 182 and the rod cutout 174 are exposed within the gear compartment 200. It should be noted that although the piston 150 is discussed as being forced through the pump chamber 224 via the piston end 216, in other embodiments, the piston 150 may be inserted into the pump chamber 224 via the back wall 211, i.e., through the gear compartment 200. Also as shown in FIG. 9B the connecting rod 146 may be positioned over and aligned with the gear compartment 200 of the second gear housing 120. In one example, the connecting rod 146 may be positioned over the gear compartment 200 such that a top edge of the piston end 186 is spaced apart from a back wall 211 of the pump extension 210.

With reference to FIG. 9C, with the piston 150 partially inserted in the pump chamber 224 and the rod cutout 174 exposed outside of the pump chamber 224, the connecting rod 146 may be inserted into the gear compartment 200 and is coupled to the piston 150. Specifically, the piston end 186 is inserted through the rod cutout 174 such that the bearing surfaces 190, 192 are received within bearings 180, 182. Once inserted, the piston end 186 of the connecting rod 146 may span between opposite sides of the piston 150, e.g., across a width of the piston cavity 236 between the two bearings 180, 182. Additionally, the shaft 188 and driven end 184 of the connecting rod 146 may extend past the bottom edge 168 of the piston 150.

As shown in in FIG. 9C, to insert the connecting rod 146 into the piston 150, the connecting rod 146 may be oriented at a first position within the gear compartment 200, e.g., adjacent to an outer perimeter wall of the drive compartment 200, with the driven end 184 of the connecting rod 146 being off-center or misaligned from the drive element support 208 and corresponding support aperture 206. In this manner, the second gear housing 120 and the gear compartment 200 may be configured to enable insertion of the length of the connecting rod 146 therein and allow the connecting rod 146, e.g., may have a diameter or width that is the same as or larger than the length of the connecting rod 146 to allow clearance for the movement of the connecting rod 146 within the gear compartment 200.

With reference to FIG. 9D, the coupled piston 150 and connecting rod 146 are moved to an operating position. Specifically, the connecting rod 146 and piston 150 are inserted into the pump chamber 224, where the piston 150 is inserted further into the pump chamber 224 and the connecting rod 146 is inserted partially into the pump chamber 224. The connecting rod 146 is move such that the driven end 184 is aligned with or at least positioned over the gear shaft support 208 and aperture 206 (see FIG. 9D). In this position, the connecting rod 146 is configured to connect to a drive element of the drive assembly 114, e.g., cam 144 and/or gear shaft 148. Once the piston 150 is fully inserted into the pump chamber 224, the interior walls of the pump extension 210, e.g., the walls defining the pump chamber 224, act to assist in retaining the connecting rod 146 within the piston 150. For example, the walls prevent the piston end 186 of the connecting rod 146 from being forced out of the rod cutout 174. In this manner, the connecting rod 146 may be fully secured to the piston 150 as the piston end 186 extends between and is received within the coupling apertures 176, 178 and is prevented from being removed via the rod cutout 174. Once coupled, movement of the connecting rod 146 is translated into movement of the piston 150 within the pump chamber 224, as discussed in more detail below.

With reference to FIG. 9D, once positioned within the piston 150, the piston end 186 of the connecting rod 146 may be configured such that the bearing surfaces 190, 192 are partially exposed to the exterior of the piston cavity 236 (e.g., are positioned and partially or completely fill the coupling apertures 176, 178 of the piston 150). Further, the bearing surfaces 190, 192 engage against the bearings 180, 182 defined by the sidewalls of the coupling apertures 176, 178. When positioned within the coupling apertures 176, 178 the dual curvature of the bearing surfaces 190, 192 allows the piston end 186 as exposed out of the piston sidewall 166 to match or correspond to the shape of the outer surface of the piston sidewall 166, helping to reduce drag and increase efficiency during use.

The piston end 186 may be configured on its own, without a secondary or external element, such as a separate pin, fastener, or the like, to secure the connecting rod 146 to the piston 150. Conventionally, many piston designs required a separate element, such as a securing pin or fastener, to be inserted to couple the piston to the rod. By eliminating a separate part, manufacturing and assembly may be easier, less expensive, and take less time.

With reference again to FIGS. 3 and 4, once the pump assembly 112 is partially assembled, e.g., the connecting rod 146 coupled to the piston 150 and the pump housing 122, the remaining components of the pump assembly 112 and drive assembly 114 may be coupled together. For example, the fitting 126 may be positioned on the piston end 216 of the pump housing 122 and specifically may be arranged over the pump chamber 224 such that the pump chamber 224 is in fluid communication with the fluid passageway 314 within the hub 300 of the fitting 126. In some embodiments, the hub 300 may be configured to receive or be positioned on a portion of the pump extension 210. For example, the portion of the piston end 216 extending past the pump plate 214 may be received within the hub 300. In these embodiments, the fitting plate 306 may be arranged adjacent to and engaging against the outer surface of the pump plate 214. It should also be noted that in embodiments where the fitting is integrally formed with the pump housing (see e.g., 14), the fitting will not need to be separately connected to the pump housing.

Optionally, a seal 151 (e.g., O-ring, U-cup, X-ring), may be positioned between an outer surface of the hub 300 and the outer surface of the pump extension 210 so as to seal the connection (see FIG. 4). Further, in some embodiments, a valve 155, which may be a one-way valve, such as a reed valve, duck bill valve, or the like, may be positioned within the hub 300 and be oriented between the pump chamber 224 and one of the pump outlets and/or pump chamber 224 and pump inlet 310. In some examples, the valve 155 may be positioned outside of the fitting 126, such as between a fluid passage between the fitting and the reservoir 102 and/or between the fitting 126 and the handle 104. In the embodiment shown in FIG. 4, the valve 155 may be positioned within the hub 300 and adjacent the valve retainer 313 and the top edge of the piston end of the pump chamber 224, which acts to secure the valve 155 within the fitting 126.

To secure the fitting 126 to the pump housing 122, one or more fasteners may be used to couple the fitting plate 306 to the pump plate 214. For example, fasteners 132a, 132b may be inserted through fastening apertures 316a, 316b of the fitting plate 306 and into fastening apertures defined by the fastening sleeves 212a, 212b. In one embodiment, the fasteners 132a, 132b are configured to extend parallel to the pump chamber 224 and in the direction of forces experienced between the pump housing 122 and the fitting 126, helping to ensure a high degree of coupling force is positioned so as to counter the experienced forces. Relatedly, the fasteners 132a, 132b are configured to be as close to the pump inlet 310 and pump outlet 312 as possible, further ensuring a tight connection. To that end, the fitting apertures 316a, 316b within the fitting 126 may be arranged to be directly adjacent to the hub 300, rather than spaced apart from the hub 300. In other words, the pump inlet 310 and pump outlet 312 and corresponding connectors 302, 304 may be radially inset from the fitting apertures 316a, 316b. Such arrangements further help to position the securing force as close to pump chamber 224.

The fitting connectors 302, 304 may then be coupled to various fluid components. For example, the inlet fitting connector 302 may be coupled, such as a via a hose, to the reservoir 102 and the outlet fitting connector 304 may be coupled, such as via a hose, to the handle 104 and tip 106.

With reference to FIGS. 3 and 4, the drive assembly 114 may be coupled to the pump assembly 112. For example, the driven gear 142 may be coupled to the connecting rod 146 and configured to move the connecting rod 146. In one embodiment, the cam 144 of the driven gear 142 is received within the driven end 184 of the connecting rod 146 with the engagement portion 152 of the driven gear 142 extending above the driven end 184 of the connecting rod 146.

The driven gear 142 and connecting rod 146 may be secured to each other and to a positon within the second gear housing 122 by the gear shaft 148. In particular the gear shaft 148 may be inserted into the shaft aperture 206 formed by the drive element support 208 formed in the second gear housing 122. The gear shaft 148 may also extend through the shaft aperture 154 of the driven gear 142 and through the cam 144 to be positioned within the shaft aperture 206 or recess.

The first gear housing 118 may be coupled to the second gear housing 122. For example, the drive element support 159 formed in the first gear housing 118 may receive the free end of the gear shaft 148 and the first gear housing 118 may be positioned over and cover the gear compartment 200 of the second gear housing 122. Interfacing edges, such as top edge 202 of the second gear housing 120 and the bottom edge 121 of the first gear housing abut one another. One or more fasteners 124a, 124b, 124c, 124d, 124e, may be inserted through one of more fastening apertures 204a, 204b, 204c, 204d, 204e of the second gear housing 120 and into corresponding fastening apertures in the first gear housing 118.

The drive gear 140 may be inserted around the drive shaft 138 and the coupled drive gear 140 and drive shaft 138 may be inserted into the shaft aperture 160 of the first gear housing 118, e.g., positioned on a motor mount of the first gear housing 118. The drive gear 140 may then be coupled to the driven gear 142, e.g., the teeth may be meshed together, such that movement of the drive gear 140 causes movement of the driven gear 142. Additionally, the motor 116 may be secured to the first gear housing 118, such as by via fasteners 124f, 124g. The pump assembly 112 and drive assembly 114 may be positioned within the housing 110 and coupled between the reservoir 102 and the tip 106.

### Operation of the Oral Irrigator

To operate the irrigator 100, a user activates the drive assembly 114, e.g., by pressing a power button or other control button, which provides power to the motor 116. The motor 116 then begins to rotate the drive shaft 138, causing the drive gear 140 to rotate. As the drive gear 140 rotates, the driven gear 142 rotates, causing the cam 144 to rotate. The cam 144 causes the connecting rod 146 to move and in some embodiments the cam 144 may be eccentric, converting the rotational movement of the driven gear 142 into a reciprocal motion of the connecting rod 146. As the connecting rod 146 moves, the piston 150 moves within the pump chamber 224.

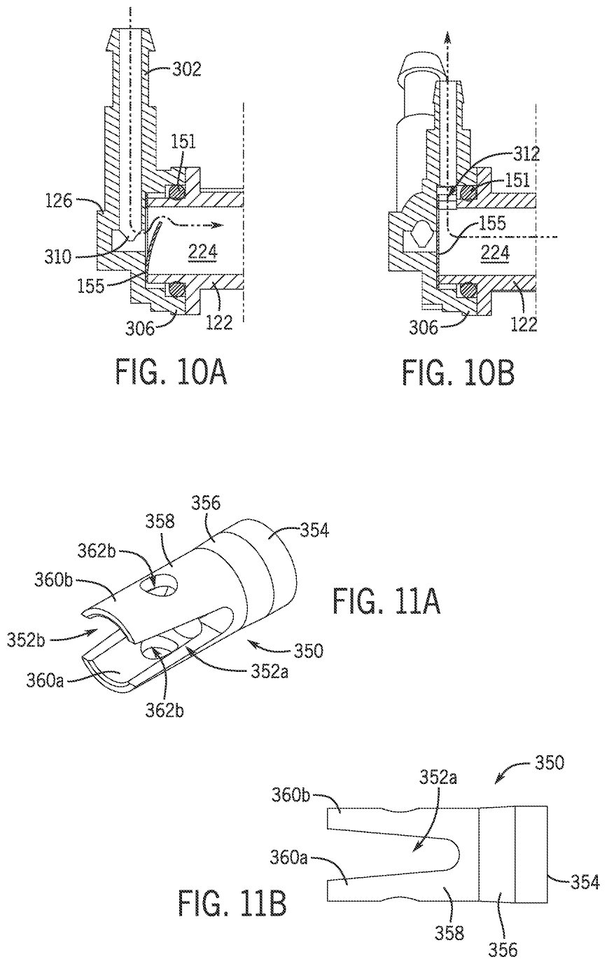

With reference to FIG. 10A, as the cam 144 pulls the connecting rod 146 away from the pump chamber 224, the piston 150 is pulled towards the back wall 211 of the pump chamber 224 creating a vacuum force, e.g., a vacuum stroke. The vacuum force pulls fluid from the reservoir 102, which enters into the pump inlet 310, and in the fluid passageway 314. The force of the fluid opens the valve 155, allowing the fluid to flow into the pump chamber 224. The sealing feature 172 of the piston 150 prevents the fluid from flowing around the piston 150 out of the pump chamber 224.

With reference to FIG. 10B, as the cam 144 continues to rotate, the connecting rod 146 is forced further into the pump chamber 224, generating a compression force on the fluid (e.g., completes a compression stroke). This force closes the valve 155, preventing fluid ingress into the pump inlet 310, and allowing the fluid to exit from the pump chamber 224 into the pump outlet 312. From the pump outlet 312, the fluid is directed to the handle 104 and out the tip 106.

### Piston Embodiments

As mentioned above, in some embodiments, the rod cutout 174 may be configured to enable insertion of the connecting rod 146 by enabling increased flexibility for the sidewalls of the piston. FIGS. 11A-12B illustrate various views of another embodiment of the piston 350 including multiple rod cutouts to assist in insertion of the connecting rod 146 into the piston 350. In this embodiment, the piston 350 may be substantially similar to the piston 150 but may include two rod cutouts and any elements not specifically mentioned may be considered to be the same as the piston 150 and/or drive assembly 114 or pump assembly 112.

With reference to FIGS. 11A-12B in one embodiment, the piston 350 may include a first rod cutout 352a and a second rod cutout 352b, which in combination or alone, act to increase the flexibility of the sidewall 358 of the piston 350. For example, the rod cutouts 352a, 352b may be defined on opposite sides of the piston 350 defining two wings 360a, 360b or tabs. These wings may then be elastically deformed, e.g., forced apart from one another to enlarge a bottom diameter of the piston 350, allowing the piston end 186 of the connecting rod 146 to be inserted into the piston cavity. In one example, the rod cutouts 352a, 352b may be defined as partial oval shapes, e.g., half an oval, with the larger width of the rod cutouts 352a, 352b being defined at the bottom edge of the piston 350. In stronger materials, two rod cutouts 352a, 352b may be used to enable easier insertion, but in other configurations, e.g., thinner sidewall thickness or different materials, a single rod cutout 352a, 352b may be used. In some embodiments, the rod cutouts 352a, 352b are positioned on different sides of the piston 350 from the coupling apertures 362a, 362b e.g., the rod cutouts 352a, 352b do not intersect with the coupling apertures 362a, 362b.

In the embodiment of FIGS. 11A-12B, the piston 350 may also include one or more coupling apertures 362a, 362b that may be configured as bearings and define one or more bearing surfaces therein. In this manner, once the connecting rod 146 is inserted into the piston 350 cavity, the piston end 186 may span across the width of the piston 350 between the two coupling apertures 362a, 362b and be positioned or at least partially received within the coupling apertures 362a, 362b, as described above with respect to the piston 150. Similarly, the piston 350 may also include a sealing feature 356, e.g., flexible skirt, O-ring, U-cup, X-ring, or the like, on an upper end thereof in order to seal against the interior walls of the pump chamber.

To insert the connecting rod 146 into the piston 350, the user may exert a force on the wings 360a, 360b pulling them outwards and away from one another, enlarging the opening at the bottom of the piston 350, e.g., causing the opening to be the same or slightly larger than a width of the piston end 186 as defined between the two bearing surfaces 190, 192. The connecting rod 146 may then be positioned such that the bearing surfaces 190, 192 are received within the coupling apertures 362a, 362b. Once positioned, the wings 360a, 360b are released, the piston sidewall 368 springs back to its original configuration, trapping the piston end 186 within the piston cavity and the bottom opening has a smaller width than the width of the piston end 186 preventing inadvertent removal of the connecting rod 146. It should be noted that the rod cutouts 352a, 352b are configured to allow the flexibly and elastic deformation of the piston 350, such that the piston 350 is not permanently altered (e.g., no stress lines or elastic deformation) by the insertion of the connecting rod 146. Further, the connecting rod 146 is coupled to the piston 350 without a separate connecting element, such as a separate pin or fastener, reducing the number of parts, enabling an easier and faster assembly process.

With reference to FIG. 13, in some embodiments, the sealing feature of the piston may be configured as a separate element, such as a seal. For example, in FIG. 13, the piston 370 includes a separate sealing feature 372 in the form of an O-ring that is received around the piston 370 outer wall towards the upper end of the piston 370. In this example, the piston 370 may be substantially similar to the piston 350, but may include an O-ring as the sealing feature 372, rather than a flexible skirt as shown in FIG. 11A. Further, while a single O-ring is shown, it can be appreciated that the sealing feature may be defined by multiple different sealing elements, e.g., two or more O-rings, X-rings, or U-cups.

### Pump Housing, Gear Housing, and Fitting Embodiments

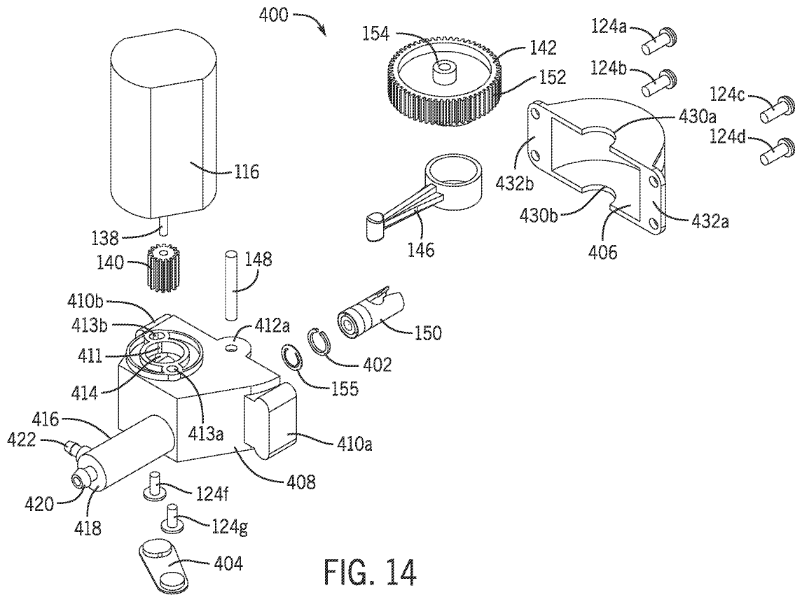

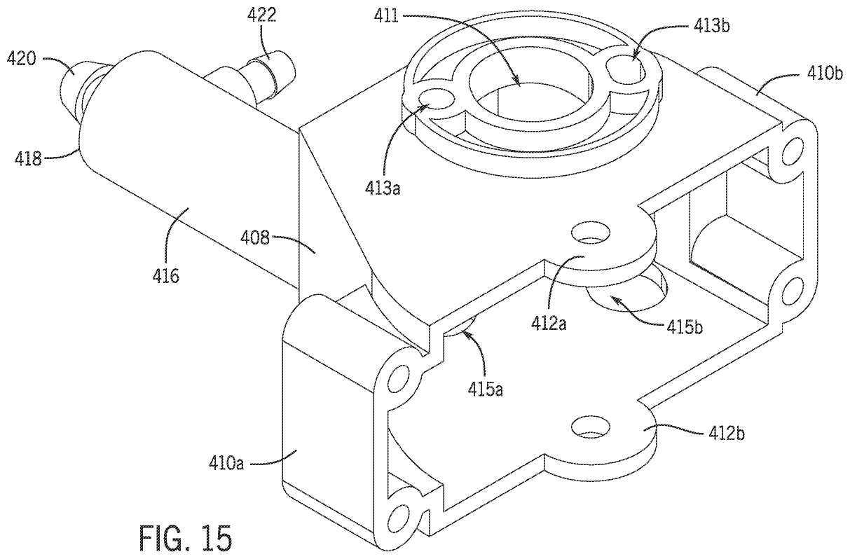

FIGS. 14 and 15 illustrate an example an integrated gear and pump housing that fully defines a drive element support. As with the various piston examples, any features not specifically discussed or mentioned with respect to FIGS. 14 and 15 may be the same as those shown in FIG. 3. With reference to FIGS. 14 and 15, in this example, the gear housing 408 is integrally formed as a pump housing 416, such as via a continuous outer wall as discussed above with respect to the second gear housing 120 and pump housing 122. In this example, however, the drive element support 412a, 412b may be defined completely by the gear housing 408. For example, the drive element support 412a, 412b may be defined on both the upper and bottom walls of the gear housing 408 by brackets that extend from either side of the walls, rather than only being defined in part by the first gear housing 120. In this manner, the drive element, such as the gear shaft 148 may extend and be secured within a feature of the gear housing 408 (rather than coupled between a first and second or upper and lower gear housing portions). It should be noted that while the drive element supports 412a, 412b are shown as including brackets with apertures to receive the gear shafts therein, in other examples, the brackets may include recesses rather than apertures.

With reference to FIG. 14, in this example, the gear housing 408 may be configured to engage with another gear housing portion, a first gear housing 406, where the combination of the two gears housings 406, 408 may act to define a drive element or gear compartment therebetween. Additionally, the gear housings 406, 408 may include engagement features, such as brackets or tabs that extend from a sidewall thereof, e.g., brackets 410a, 410b that engage with brackets 432a, 432b on gear housing 406. In this manner, one or more fasteners may be used to extend between the brackets 410a, 410b, 432a, 432b, coupling the gear housings 406 408 together. Similarly, as the gear housing 408 includes drive element supports 412a, 412b, the gear housing 406 may include cutouts 430a, 430b to receive the drive elements supports 412a, 412b when the gear housings 406, 408 are coupled together. In these embodiments, because the pump housing 416 (which defines the pump chamber) is formed with the gear housing 408 that includes the drive element supports 412a, 412b, the components will not move relative to each other, helping to increase efficiency for the pump assembly, as well as reduce the amount of parts needed and easing manufacture of the oral irrigator 100.

Further, as shown in FIGS. 14 and 15, the gear housing 408 may also define the motor mount 414 therein. In this manner, the motor mount 414, the pump housing 416, and the drive element supports 412a, 412b may be defined in a single integrally formed member, e.g. by a continuous wall rather than separate elements that are individually coupled together, such as via fasteners or adhesive. Such an arrangement further helps to ensure or increase the efficiency of the pump and drive assemblies. In this embodiment the motor mount 414 includes a drive aperture 411 to receive the drive shaft 138 and/or drive gear 140 therethrough and optionally may include one or more motor fastening apertures 413a, 413b to receive on or more fasteners to secure the motor 116 to the gear housing 408. In these embodiments, an optional motor cover 404 may be used to cover the fastening apertures 415a, 415b when the motor 116 is secured to the gear housing 408.

Relatedly, in this example, the pump fitting 418 may be formed integrally with the pump housing 416, e.g., by a continuous wall and/or as a single part. For example, the pump inlet and outlet ports may be formed as apertures within the outer pump housing 416 wall and in communication with the pump chamber and the inlet connector 420 and outlet connector 422 may be directly extend from the pump housing 416. As a specific implementation, the pump housing 416 may be injection molded such that the fitting 418 and connectors 420, 422 are formed together with the pump housing 416. In this manner, leakage between the pump fitting and the pump chamber may be reduced, as well as the manufacturing and assembly of the pump assembly may be easier due to a reduction of parts and connections. In these embodiments, the position between the pump inlet and pump outlet may be reduced as compared to a separate fitting, allowing more compact pump assembly configurations than in conventional devices.

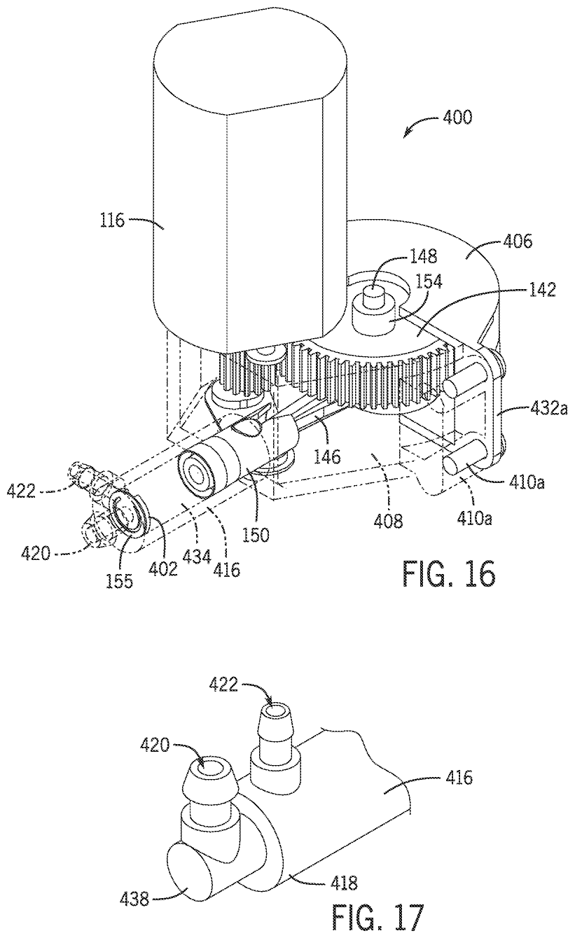

In some embodiments, the inlet connector 420 and the outlet connector 422 may be oriented at different angles from one another, such as offset by 90 degrees from one another. As shown in FIGS. 15 and 16, the inlet connector 420 may extend from the back wall of the pump fitting 418 and be parallel to a longitudinal axis of the pump chamber 434. The outlet connector 422 may extend from a sidewall of the fitting 418 and be oriented perpendicular to the pump chamber 434. However, in other embodiments, the connectors may be differently configured. For example, with reference to FIG. 17, in this example, the pump inlet and pump outlet may be formed through the same wall of the pump fitting 418 and the inlet connector 420 and outlet connector 422 may both extend away from the pump housing 416 at the same angle and in the same direction, e.g., perpendicular to a longitudinal axis of the pump chamber 434. This may assist in coupling hoses, tubes, or the like to the pump fitting 418, as well as save space. In this configuration, the terminal end of the fitting 418 may be defined by a closed end wall 438, rather than as shown in FIGS. 15 and 16 as including a connector.

With reference to FIG. 16, in some embodiments, such as when the pump fitting 418 is integrated with the pump housing 416, a valve retainer 402 may be positioned within a pump chamber 434 to assist with retaining the valve 155 within the pump chamber 434 and in a desired configuration, such as positioned between the pump outlet and pump inlet. In one example, the valve retainer 402 may be formed as a separate clamp that is flexible to allow insertion through the open end of the pump chamber 434 towards the fitting 418. For example, the valve retainer 402 may be a C-clamp that can be deformed to insert within the pump chamber 434 and expand outwards once in the desired location, to retain the valve 155 in a desired location. In other embodiments, the valve retainer 402 may be integrated into the pump chamber 434, such as by a formation within the wall or the like. In various embodiments, the valve retainer 402 may include a cutout, through hole, or the like that allows fluid flow, e.g., allow fluid to flow through the valve retainer 402 to flow between the pump inlet, pump chamber, and pump outlet. Further, the pump housing 416 and/or valve retainer 402 may include an anti-clocking mechanism, such as a recess, tab, or the like, that helps to ensure that the valve retainer 402 and valve 155 remain secured in a desired orientation within the pump housing 416.

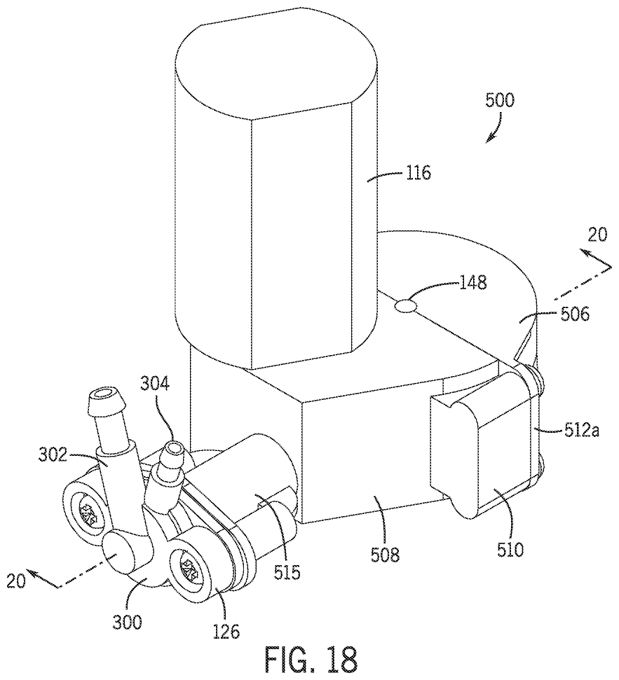

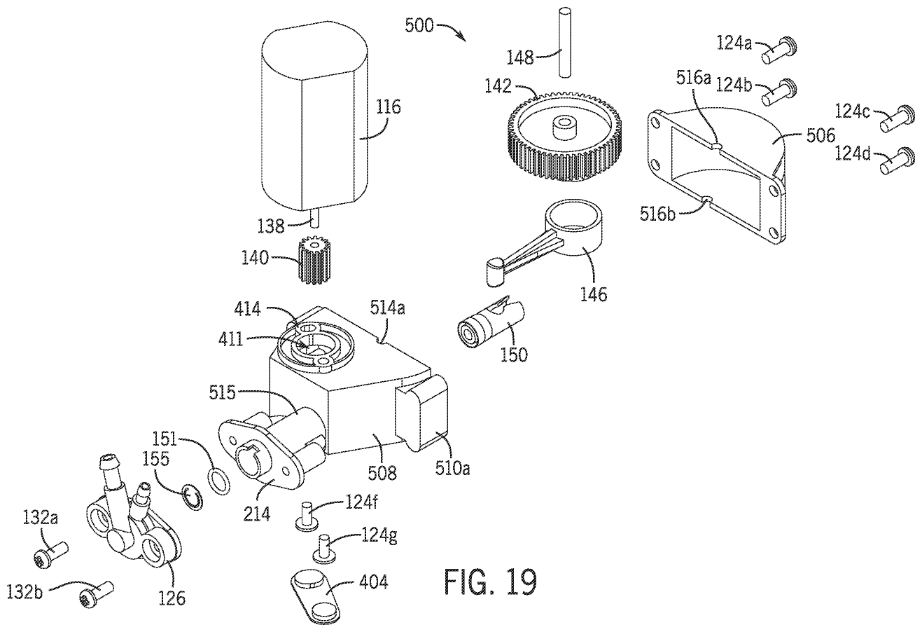

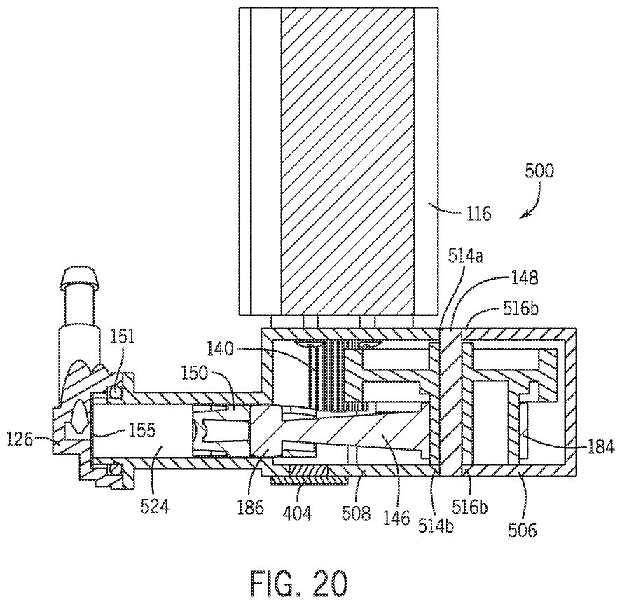

FIGS. 18 and 19 illustrate another example of a gear housing. With reference to FIGS. 18 and 19, the gear housing may include a first gear housing 506 and a second gear housing 508 (e.g., two gear housing portions), where like other embodiments, the pump housing 515 is formed integrally with the second gear housing 508. However, in this example, a first drive element support 514a and a second drive element support 514b may be formed in part by the second gear housing 508, e.g. on the top and bottom walls of the second gear housing 508. In particular, the drive element support 514a, 514b may be formed as a partial recess, e.g., semicircular cutout formed in the sidewall of the terminal edge of the second gear housing 508 may be configured to engage with the first gear housing 506 to define a complete drive element support. For example, the first gear housing 506 may include corresponding drive element supports 516a, 516b, which also may be in the form or a recess or cutout. In this example, the gear shaft 148 may be positioned between the two gear housings 506, 508 and retained within the drive element supports 514a, 516a and 514b, 516b as the two gear housings 506, 508 are compressed and secured together, e.g., the securing brackets 510a, 512b are coupled together via one or more fasteners. FIG. 20 illustrates a cross-section view of the gear housing of FIGS. 18 and 19, with reference to FIG. 20, the compression of the gear shaft 148 between the two gear housings 506, 508 is shown. In this example, the drive element supports 514a, 514b, 516a, 516b act together to capture or retain the gear shaft 148 in a position relative to the terminal walls of the gear housings 506, 508 and the fasteners that secure the gear housings together help to ensure that the gear shaft 148 does not move and is secured in place.

### CONCLUSION

It should be noted that any of the embodiments, examples, or components of the drive assembly and/or pump assembly in any of the figures may be used with different embodiments, examples, or components. For example an integrated pump fitting may be used in place of the separate fitting shown in FIG. 3, with any of the gear housing configurations. As another example, the separate valve retainer of FIG. 14 may be used with any of the pump chamber and fitting iterations, such as the one shown in FIG. 3, even if the fitting is different from the fitting shown in FIG. 14. As yet another example, the integration of the gear housing, motor mount, and pump housing may be used with any of the other configurations, including separate or integrally formed pump fittings, or vertically or horizontally separated gear housing iterations. In yet another example, the various piston configurations, including both the number and configuration of the rod apertures and/or the sealing feature, may be used with any embodiment as may be desired. As such, it should be understood that the various components may be modular and interchangeable depending on space and fluid connections within the housing of the oral irrigator, etc. To this end, any description of a particular component being part of a particular embodiment, is meant as illustrative only and should not be interpreted as being required to be used with a particular embodiment or requiring other elements as shown in the depicted embodiment.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. An oral irrigator comprising:
a connecting rod; and
a piston comprising:
a sidewall defining a piston cavity; and
a rod cutout defined in the sidewall, wherein the rod cutout enables insertion of a portion of the connecting rod into the piston cavity, wherein after insertion the connecting rod extends from the piston cavity past a bottom edge of the sidewall.

2. The oral irrigator of claim 1, wherein the piston further comprises:
a closed top end coupled to the sidewall;
a bottom open end defined by the bottom edge of the sidewall, wherein the rod cutout extends from a portion of the bottom edge upwards towards the closed top end; and
a coupling aperture configured to receive a portion of a piston end of the connecting rod.

3. The oral irrigator of claim 2, wherein the coupling aperture comprises a first coupling aperture positioned on a first side of the sidewall and a second coupling aperture positioned on a second side of the sidewall, wherein the second coupling aperture forms a portion of the insertion aperture.

4. The oral irrigator of claim 3, wherein:
the connecting rod defines a piston end that extends between the first coupling aperture and the second coupling aperture; and
the piston further comprises a bearing for engaging with the piston end of the connecting rod.

5. The oral irrigator of claim 4, wherein:
the bearing is formed as a coupling aperture defined within the sidewall of the piston; and
the first end of the connecting rod comprises a curved bearing surface, wherein the curved bearing surface is positioned within and engages the bearing.

6. The oral irrigator of claim 5, wherein the curved bearing surface is curved in a first direction parallel to a longitudinal axis of the connecting rod and curved in a second direction perpendicular to the longitudinal axis of the connecting rod.

7. (canceled)

8. (canceled)

9. The oral irrigator of claim 1, wherein the piston end spans across a width of the piston and the connecting rod is inserted into the piston cavity via a sidewall of the piston.

10. The oral irrigator of claim 1, wherein the piston is secured to the connecting rod without a fastener.

11. (canceled)

12. An oral irrigator comprising:
a reservoir;
a handle fluidly connected to the reservoir; and
a pump configured to pump fluid from the reservoir to the handle, comprising:
a connecting rod; and
a piston coupled to the connecting rod, wherein the piston comprises a rod cutout defined within a sidewall of the piston.

13. The oral irrigator of claim 12, wherein the connecting rod comprises a first end and a second end, wherein the first end couples to the piston such that after insertion of the connecting rod, the piston moves correspondingly with the connecting rod.

14. The oral irrigator of claim 12, wherein a portion of the first end of the connecting rod is received into the sidewall of the piston.

15. The oral irrigator of claim 14, wherein the portion is curved in at least one direction.

16.-20. (canceled)

21. An oral irrigator comprising:
a drive assembly;
a pump housing defining a pump chamber; and
a gear housing configured to secure a drive element of the drive assembly in a position within the gear housing, wherein the pump housing and the gear housing are formed by a single wall.

22. The oral irrigator of claim 21, wherein the drive element comprises a gear shaft, wherein the drive assembly further comprises a gear rotationally coupled to the gear shaft.

23. The oral irrigator of claim 21, wherein the gear housing further comprises a support formed in part by the wall of the gear housing, wherein the support is configured to secure the drive element.

24. The oral irrigator of claim 23, wherein the support is formed fully by the wall of the gear housing.

25. The oral irrigator of claim 21, wherein the single wall prevents separate movement of the pump chamber and the drive element relative to one another.

26. The oral irrigator of claim 21, further comprising a gear cover operably coupled to the gear housing to enclose a portion of the gear housing, wherein the gear housing comprises a first support for supporting a first end of the drive element and the gear cover comprises a second support for supporting a second end of the drive element, wherein the drive element is a gear shaft.

27.-30. (canceled)

31. The oral irrigator of claim 21, wherein the pump housing comprises an extension extending from a portion of the wall of the gear housing, wherein the extension defines the pump chamber therein.

32. The oral irrigator of claim 31, further comprising a fitting coupled to the pump housing and fluidly coupled to the pump chamber, wherein the fitting is configured to deliver and receive fluid from the pump chamber, wherein the fitting is secured to the pump housing by one or more fasteners, wherein the one or more fasteners are arranged to extend parallel to the pump chamber.

34.-63. (canceled)
